(19) United States
(12) Patent Application Publication
(10) Pub. No.: US 2026/0239250 A1
(43) Pub. Date: Aug. 13, 2026

(54) PRE-COMPENSATING TIMING DRIFT

(71) Applicant: Nokia Technologies Oy, Espoo (FI)

(72) Inventors: Alessio MARCONE, Munich (DE); Arman AHMADZADEH, Munich (DE); Frank FREDERIKSEN, Klarup (DK)

(21) Appl. No.: 19/472,739

(22) PCT Filed: Apr. 18, 2024
(86) PCT No.: PCT/EP2024/060475

§ 371 Date: Oct. 6, 2025

(30) Foreign Application Priority Data
May 5, 2023 (FI) 20235501

(51) Int. Cl. H04W 56/00

(52) U.S. Cl. CPC H04W 56/0045

(57) ABSTRACT

There is provided a method, comprising: determining a time domain window during which a plurality of transmissions is to take place; determining a pre-compensation value for a timing drift value, where-in the pre-compensation value is based on a prediction of timing drift that is expected to take place on the plurality of transmissions during the time do-main window; adjusting the timing of the plurality of transmissions based on the pre-compensation value; and perform-ing the plurality of transmissions based on the adjusted timing.

### TECHNICAL FIELD

Various example embodiments relate generally to pre-compensation of timing drift, e.g. in non-terrestrial networks.

### BACKGROUND

It is known to use timing advance for transmission of signals, such as uplink signals, in order to alleviate decoding at a receiver. However, sometimes the timing advance changes rapidly, which may cause issues for the communication.

### BRIEF DESCRIPTION

According to some aspects, there is provided the subject matter of the independent claims. Some further aspects are defined in the dependent claims. The embodiments that do not fall under the scope of the claims are to be interpreted as examples useful for understanding the disclosure.

### LIST OF THE DRAWINGS

In the following, the invention will be described in greater detail with reference to the embodiments and the accompanying drawings, in which

FIG. 1A presents a network to which one or more embodiments are applicable;

FIG. 1B presents a non-terrestrial network, according to an embodiment;

FIG. 2 shows an example of partitioning nTDW into multiple aTDWs;

FIG. 3 shows how timing drift may vary as a function of elevation angle;

FIGS. 4 and 5 show methods, according to some embodiments;

FIGS. 6 to 9 illustrate how the UE may determine a pre-compensation value, according to some embodiments;

FIG. 10 shows how timing drift may affect the reception of uplink transmissions, according to an embodiment;

FIG. 11 is a signaling flow diagram, according to an embodiment; and

FIGS. 12 and 13 illustrate apparatuses, according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. For the purposes of the present disclosure, the phrases “at least one of A or B”, “at least one of A and B”, “A and/or B” means (A), (B), or (A and B). For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments.

Embodiments described may be implemented in a radio system, such as one comprising at least one of the following radio access technologies (RATs): Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and enhanced LTE (eLTE). Term ‘eLTE’ here denotes the LTE evolution that connects to a 5G core. LTE is also known as evolved UMTS terrestrial radio access (EUTRA) or as evolved UMTS terrestrial radio access network (EUTRAN). A term “resource” may refer to radio resources, such as a physical resource block (PRB), a radio frame, a subframe, a time slot, a subband, a frequency region, a subcarrier, a beam, etc. The term “transmission” and/or “reception” may refer to wirelessly transmitting and/or receiving via a wireless propagation channel on radio resources

The embodiments are not, however, restricted to the systems/RATs given as an example but a person skilled in the art may apply the solution to other communication systems/networks provided with necessary properties. Some examples of a suitable communication networks include a 5G network and/or a 6G network. The 3GPP solution to 5G is referred to as New Radio (NR). 6G is envisaged to be a further development of 5G. NR has been envisaged to use multiple-input-multiple-output (MIMO) multi-antenna transmission techniques, more base stations or nodes than the current network deployments of LTE (a so-called small cell concept), including macro sites operating in co-operation with smaller local area access nodes and perhaps also employing a variety of radio technologies for better coverage and enhanced data rates. 5G will likely be comprised of more than one radio access technology/radio access network (RAT/RAN), each optimized for certain use cases and/or spectrum. 5G mobile communications may have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and being integrable with existing legacy radio access technologies, such as the LTE.

The current architecture in LTE networks is distributed in the radio and centralized in the core network. The low latency applications and services in 5G may require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications). Edge cloud may be brought into RAN by utilizing network function virtualization (NVF) and software defined networking (SDN). Using edge cloud may mean access node operations to be carried out, at least partly, in a server, host or node operationally coupled to a remote radio head or base station comprising radio parts. Network slicing allows multiple virtual networks to be created on top of a common shared physical infrastructure. The virtual networks are then customised to meet the specific needs of applications, services, devices, customers or operators.

In radio communications, node operations may in be carried out, at least partly, in a central/centralized unit, CU, (e.g. server, host or node) operationally coupled to distributed unit, DU, (e.g. a radio head/node). It is also possible that node operations will be distributed among a plurality of servers, nodes or hosts. It should also be understood that the distribution of work between core network operations and base station operations may vary depending on implementation. Thus, 5G networks architecture may be based on a so-called CU-DU split. One gNB-CU controls several gNB-DUs. The term ‘gNB’ may correspond in 5G to the eNB in LTE. The gNBs (one or more) may communicate with one or more UEs. The gNB-CU (central node) may control a plurality of spatially separated gNB-DUs, acting at least as transmit/receive (Tx/Rx) nodes. In some embodiments, however, the gNB-DUs (also called DU) may comprise e.g. a radio link control (RLC), medium access control (MAC) layer and a physical (PHY) layer, whereas the gNB-CU (also called a CU) may comprise the layers above RLC layer, such as a packet data convergence protocol (PDCP) layer, a radio resource control (RRC) and an internet protocol (IP) layers. Other functional splits are possible too. It is considered that skilled person is familiar with the OSI model and the functionalities within each layer.

In an embodiment, the server or CU may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU and the boundary where the responsibility is shifted between the CU and the DU may be selected according to implementation.

Some other possible technology advancements to be used are Software-Defined Networking (SDN), Big Data, and all-IP, to mention only a few non-limiting examples. For example, network slicing may be a form of virtual network architecture using the same principles behind software defined networking (SDN) and network functions virtualisation (NFV) in fixed networks. SDN and NFV may deliver greater network flexibility by allowing traditional network architectures to be partitioned into virtual elements that can be linked (also through software). Network slicing allows multiple virtual networks to be created on top of a common shared physical infrastructure. The virtual networks are then customised to meet the specific needs of applications, services, devices, customers or operators.

The plurality of gNBs (access points/nodes), each comprising the CU and one or more DUs, may be connected to each other via the Xn interface over which the gNBs may negotiate. The gNBs may also be connected over next generation (NG) interfaces to a 5G core network (5GC), which may be a 5G equivalent for the core network of LTE. Such 5G CU-DU split architecture may be implemented using cloud/server so that the CU having higher layers locates in the cloud and the DU is closer to or comprises actual radio and antenna unit. There are similar plans ongoing for LTE/LTE-A/eLTE as well. When both eLTE and 5G will use similar architecture in a same cloud hardware (HW), the next step may be to combine software (SW) so that one common SW controls both radio access networks/technologies (RAN/RAT). This may allow then new ways to control radio resources of both RANs. Furthermore, it may be possible to have configurations where the full protocol stack is controlled by the same HW and handled by the same radio unit as the CU.

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future rail-way/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The embodiments may be also applicable to narrow-band (NB) Internet-of-things (IoT) systems which may enable a wide range of devices and services to be connected using cellular telecommunications bands. NB-IoT is a narrowband radio technology designed for the Internet of Things (IoT) and is one of technologies standardized by the 3rd Generation Partnership Project (3GPP). Other 3GPP IoT technologies also suitable to implement the embodiments include machine type communication (MTC) and eMTC (enhanced Machine-Type Communication). NB-IoT focuses specifically on low cost, long battery life, and enabling a large number of connected devices. The NB-IoT technology is deployed “in-band” in spectrum allocated to Long Term Evolution (LTE)-using resource blocks within a normal LTE carrier, or in the unused resource blocks within a LTE carrier's guard-band- or “standalone” for deployments in dedicated spectrum.

The embodiments may be also applicable to device-to-device (D2D), machine-to-machine, peer-to-peer (P2P) communications. The embodiments may be also applicable to vehicle-to-vehicle (V2V), vehicle-to-infrastructure (V2I), infrastructure-to-vehicle (I2V), or in general to V2X or X2V communications.

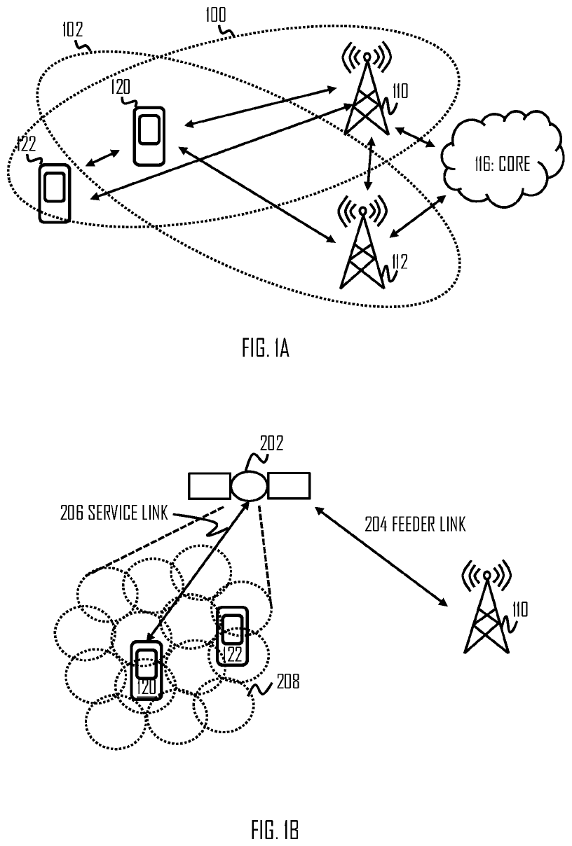

FIG. 1A illustrates an example of a communication system to which embodiments of the invention may be applied. The system may comprise a control node 110 providing one or more cells, such as cell 100, and a control node 112 providing one or more other cells, such as cell 102. Each cell may be, e.g., a macro cell, a micro cell, femto, or a pico cell, for example. In another point of view, the cell may define a coverage area or a service area of the corresponding access node. The control node 110, 112 may be an evolved Node B (eNB) as in the LTE and LTE-A, ng-eNB as in eLTE, gNB of 5G, or any other apparatus capable of controlling radio communication and managing radio resources within a cell. The control node 110, 112 may be called a base station, network node, or an access node.

The system may be a cellular communication system composed of a radio access network of access nodes, each controlling a respective cell or cells. The access node 110 may provide user equipment (UE) 120 (one or more UEs) with wireless access to other networks such as the Internet. The wireless access may comprise downlink (DL) communication from the control node to the UE 120 and uplink (UL) communication from the UE 120 to the control node.

Additionally, although not shown, one or more local area access nodes may be arranged such that a cell provided by the local area access node at least partially overlaps the cell of the access node 110 and/or 112. The local area access node may provide wireless access within a sub-cell. Examples of the sub-cell may include a micro, pico and/or femto cell. Typically, the sub-cell provides a hot spot within a macro cell. The operation of the local area access node may be controlled by an access node under whose control area the sub-cell is provided. In general, the control node for the small cell may be likewise called a base station, network node, or an access node.

There may be a plurality of UEs 120, 122 in the system. Each of them may be served by the same or by different control nodes 110, 112. The UEs 120, 122 may communicate with each other, in case D2D communication interface is established between them.

The term “terminal device” or “UE” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In the case of multiple access nodes in the communication network, the access nodes may be connected to each other with an interface. LTE specifications call such an interface as X2 interface. For IEEE 802.11 network (i.e. wireless local area network, WLAN, WiFi), a similar interface may be provided between access points. An interface between an LTE access point and a 5G access point, or between two 5G access points may be called Xn. Other communication methods between the access nodes may also be possible. The access nodes 110 and 112 may be further connected via another interface to a core network 116 of the cellular communication system. The LTE specifications specify the core network as an evolved packet core (EPC), and the core network may comprise a mobility management entity (MME) and a gateway node. The MME may handle mobility of terminal devices in a tracking area encompassing a plurality of cells and handle signalling connections between the terminal devices and the core network. The gateway node may handle data routing in the core network and to/from the terminal devices. The 5G specifications specify the core network as a 5G core (5GC), and there the core network may comprise e.g. an access and mobility management function (AMF) and a user plane function/gateway (UPF), to mention only a few. The AMF may handle termination of nonaccess stratum (NAS) signalling, NAS ciphering & integrity protection, registration management, connection management, mobility management, access authentication and authorization, security context management. The UPF node may support packet routing & forwarding, packet inspection and QoS handling, for example.

As part of the 3GPP Rel-17 work there was discussion of being able to support communication between satellites and UEs, i.e. so called non-terrestrial network (NTN). It is important to enable communication that would make such satellite based system work, even when satellites are moving at high speeds (7500 m/s at low earth orbit) and potentially having extremely long round trip times (due to satellites being at 36000 km altitude for geostationary/geosynchronous orbits, which causes a round trip time of ~0.5 seconds).

FIG. 1B shows an example NTN scenario. NTN targets at enabling communication even when satellites 202 are moving at high speeds (7500 m/s at low earth orbit) and potentially having extremely long round trip times. For the Rel-17 work, the general assumption was that the satellites 202 used for the communication would be operating in “transparent mode”, meaning that the satellites 202 would be seen as mobile remote radio heads, while the normal 5G base station 200 would be located on earth. For this scenario the communication link between the gNB (e.g. modified gNB 110) and the UE 120/122 would be divided into two radio links. The feeder link 204 (between the gNB and the satellite) and the service link 206 (between the satellite and the UE). Reference numeral 208 depicts a typical beam footprint for a LEO satellite, which is assumed to be between 100-1000 km in radius.

One of the main challenges in the communication using NTN is that satellites in LEO are moving at high velocity, thereby causing the path distance for both the feeder link and the service link to change as a function of time. To solve this problem, it is assumed that the UE is equipped with a functionality that can provide the UE its geo-location (e.g. through GNSS-Global Navigation Satellite System-GPS, GloNass, Galileo as examples of such systems). By the UE knowing its own location, and the satellite's position in space it is possible for the UE to calculate or estimate the impairments that are experienced for the service link (estimation of path length can be converted into a time delay and knowing the satellite's velocity and direction can allow the UE to calculate and compensate the experienced Doppler shift from satellite (and UE) movement). For the feeder link, the gNB will in a similar way provide information that is descriptive of the time-variation. Such information for the feeder link is known as Common timing advance (TA) related parameters and may be used by the UE to perform additional pre-compensation of impairments that are seen on the feeder link (the gNB or the satellite subsystem is expected to compensate for the Doppler offset that is experienced on the feeder link). Since the satellite location information (determinable from e.g. serving satellite's ephemeris information) is dynamic in nature, this satellite location information is further provided with two parameters:
Epoch time: The definition of the time by which the information is to be seen as “valid”. This is important due to the high velocity of the LEO satellite, which affects understanding at the UE side of the satellite's position at a given time.
Validity timer: An indication from the gNB side which tells the UE for how long after the Epoch time the UE may see the provided ephemeris information of the satellite to be applicable. This may serve to ensure that the UE is not using information that is outside of the “prediction horizon”, which might happen for the common TA related parameters which essentially represents a second order polynomial approximation of the Feeder link's time delay.

In NTN, the Timing Advance (TA) is calculated at the UE as

$$( {N}_{TA} + {N}_{TA - offset} + {N}_{TA , adj}^{common} + {N}_{TA , adj}^{UE} ) * {T}_{c} ,$$

wherein N_{TA} and N_{TA-offset} are the parameters also used in terrestrial networks by the UEs for calculating the TA and indicated by the network, whereas

$${N}_{TA , adj}^{common} and {N}_{TA , adj}^{UE}$$

are NTN specific TA parameters, used by an NTN UE to compensate for the large round-trip time (RTT) of NTN communications. In particular,

$${N}_{TA , adj}^{UE}$$

is a UE specific TA and accounts for the delay of the service link, i.e., the delay between the satellite and the UE. UE specific

$$TA ( {N}_{TA , adj}^{UE} )$$

is acquired autonomously by UE based on the provided satellite ephemeris information broadcast and UE estimate of the distance between UE and satellite via GNSS.

$${N}_{TA , adj}^{common}$$

is instead a common TA, which accounts for the delay of the feeder link (i.e., the delay between the satellite and the gNB) and it is provided to UE by the gNB by providing parameters for a 2nd order polynomial description of the Common TA.

As a result, updating either of these components leads to an update of the final value of TA. Currently there is no definition in the specification as to exactly when the UE should update and apply the calculated values of the TA components belonging to the operation of NR over NTN.

In the Rel-17 NR coverage enhancement work item, DM-RS bundling framework, was introduced to enable improved channel estimation for PUSCH/PUCCH. This includes repetitive transmissions of DM-RS, for example. Some of the important aspects of DM-RS bundling framework are summarized as follows:
DM-RS bundling can be used for PUSCH repetition Type A scheduled by DCI format 0_1 or 0_2, for PUSCH repetition Type A with configured grant, for PUSCH repetition Type B, for TB processing over multiple slots PUSCH and for PUCCH repetitions of PUCCH formats 1, 3, and 4.
A UE can report a maximum duration (maxDMRS-BundlingDuration), in number of consecutive slots, during which the UE is able to maintain power consistency and phase continuity under certain tolerance level.
With the duration of the nominal TDWs (time domain windows) not longer than the maximum duration, configured by gNB, one or multiple nominal TDWs (nTDW) can be determined for PUSCH transmissions or PUCCH repetitions.
A nTDW may comprise one or multiple actual TDWs, which are determined based on events which cause power consistency and phase continuity not to be maintained across PUSCH transmissions or PUCCH repetitions within the nominal TDW.
An actual TDW (aTDW) is terminated in case an event occurs. A new actual TDW is created in response to semi-static events not triggered by DCI or MAC-CE. Whether a new actual TDW is created in response to dynamic events triggered by DCI is subject to UE capability.
The UE shall maintain power consistency and phase continuity within an actual TDW across PUSCH transmissions or PUCCH repetitions.

In other words, a gNB can configure a length of an nTDW, each nTDW starting either at the start of the multiple UL transmissions (e.g. UL repetitions) or right after the end of another nTDW (e.g. in case the length of the nTDW is shorter than the length of the UL repetitions). Each nTDW may comprise (or consists of) one or multiple aTDWs, in case there is at least an event that happens in the nTDW that breaks power consistency and phase continuity. The events are defined in 3GPP specs as:
DL slot or DL reception/monitoring based on semi-static DL/UL configuration for TDD.
Gap between two consecutive PUSCH/PUCCH transmissions greater than: 13 symbols for normal cyclic prefix (CP) or 11 symbols for extended CP.
Other UL transmissions in the middle of two consecutive PUSCH/PUCCH transmissions.
A dropping or cancellation of a PUSCH/PUCCH transmission.
UL beam switching in case of jointly configured with multi-TRP operation.
Uplink timing adjustment in response to a timing advance command.
Frequency hopping.
   Actual TDWs may then be determined as follows:
The start of the first aTDW is the first symbol of the first PUSCH/PUCCH transmission within the nTDW.
The end of the of the last aTDW is the last symbol of the last PUSCH/PUCCH transmission within the nTDW.
The start of other aTDW is the first symbol of the PUSCH/PUCCH transmission after the event.
The end of other aTDW is the last symbol of a PUSCH/PUCCH transmission before the event.
UE shall maintain power consistency and phase continuity within an actual TDW.

For the sake of clarity, nTDW and aTDW determination for a simple scenario of 4 PUSCH repetitions is shown in FIG. 2, with an event (any of the list above) that breaks power consistency and phase continuity between the 2nd and 3rd repetition. Because of the event, the nTDW (assumed to span the whole duration of the PUSCH repetitions) is split into two aTDW, i.e. aTDW #1 and aTDW #2, spanning two repetition each, within which UE keeps phase and power consistency. In simpler terms, one can say that the DM-RS bundling framework is an extension of the possibility for enhancing the coverage of UL transmissions.

In previous releases it was possible to configure UEs to perform PUSCH repetitions (provided that UEs were capable of this), and hence allow the base station to capture the energy from the individual uplink transmissions to enhance the received quality and hence obtain better detection reliability in poor channel conditions. In the pre-Rel-17 coverage enhancement configuration, each UL transmission of PUSCH would be confined within a single slot, which would be seen as independent from neighboring slots. In the Rel-17 coverage enhancement work, one change that is implied is that there is a commitment from UE side to maintain phase continuity between neighboring slots (e.g. within the time domain window-TDW), which would allow for the gNB to perform cross-slot processing. Such cross-slot processing might, for instance, be utilizing the reference signals (e.g. demodulation reference signals, DM-RS) across slots to enhance the channel estimate, as well as combining the received signals for the actual PUSCH samples.

UL PUSCH repetitions is a feature used to increase the coverage of the UL transmissions, wherein a UE repeats the same transport block (e.g. data) in different slots giving the possibility to a gNB receiver to combine the different repetitions and have a more reliable estimate of the transmitted information. Due to their nature, UL repetitions take an amount of time proportional to the scheduled number of repetitions and the subcarrier spacing (SCS) of the UL transmission. For example, if 20 repetitions are scheduled and the UL transmission is performed with an SCS of 15 kHz (for which a slot lasts 1 ms), the UL repetitions would last 20 ms if the slots are consecutive. This is the case in NTN for example, since the NTN bands are FDD bands and consecutive slots are always available for UL repetitions.

UL repetitions in NTN are affected by large timing drifts due to the fast movement of the satellites. In other words, within the time of the UL repetitions, the delay between the satellite and the UE changes causing the UL repetitions to be received at different times by the gNB receiver. This is not a problem as long as the repetitions are received within the Cyclic Prefix (CP) of the UL transmissions, but such a condition needs to be necessarily satisfied to maintain orthogonality of the UL transmission.

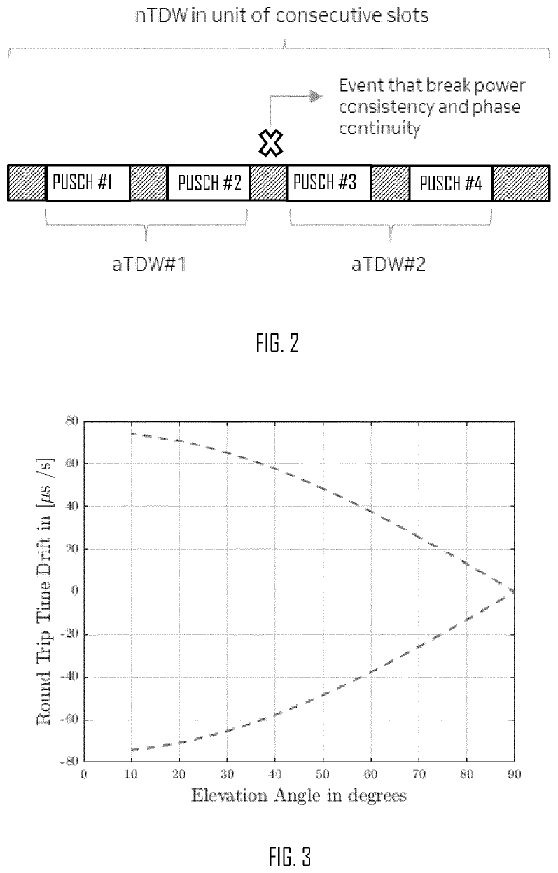

The value and the sign of such timing drift may be respectively dependent on the elevation angle between the UE and the satellite and on the direction of motion of the satellite relative to the UE, as also shown in FIG. 3. It is to be noticed that for a certain elevation angle, two values with opposite sign of the timing drift are possible depending on whether the satellite is approaching the UE or is leaving the UE. For example, for an elevation angle of 30 degrees, both 65 us/s and −65 us/s are possible, in the case the satellite is approaching or leaving the UE, respectively.

DM-RS bundling is a technique that can jointly be exploited with PUSCH repetitions to help improving the performance of channel estimation algorithms at gNB and provide performance gain. However, to be able to realize the promised performance gain of DM-RS bundling, several conditions need to be met first. The two most important criterions are power consistency and phase continuity, allowing to have similar channel responses in the slots of the PUSCH repetitions and allowing a gNB to coherently combine the corresponding channel estimates.

Maintenance of power consistency and phase continuity is however a non-trivial task for the UE. For this reason, the 3GPP specs include the mentioned list of events that allow a UE to not satisfy (or even break) the consistency conditions. One of such events occurs when UE updates the timing advance (TA) of its UL transmissions, i.e. whenever UE updates any of the component of the TA as described above. In such a case, the UE is expected to stop the DMRS bundling process and resume it only after updating of the TA for the UL transmission. If in terrestrial networks such an event is not very frequent due to the fact that the channel does not change substantially in the time of UL repetitions and hence a UE can normally transmit the UL repetitions without updating its TA, the situation is different in NTN. UL repetitions in NTN are affected by large timing drift, leading to a more frequent update of the TA and therefore to more frequent interruptions of the DMRS bundling at the UE. Such a limitation leads to a degradation of the DMRS bundling performance in NTN (as multiple, and in turn shorted, aTDW need to be created), and solutions to address such problem are needed.

In addition, NTN UEs perform not only network-controlled TA updates but also autonomous TA updates to continuously compensate for the change in the delay between the satellite and the UE as well as to compensate for the delay on the feeder link

$$( {N}_{TA , adj}^{UE} and {N}_{TA , adj}^{common}$$

in 3GPP terminology, respectively). The application times of the autonomous TA updates are however not known to the gNB, creating ambiguity in DMRS bundling operation if such autonomous update occurs within a DMRS bundling window. Indeed, if the UE breaks the phase continuity of the DMRS transmissions for TA updates and gNB is not aware of it, gNB may risk of combining non-coherent channel estimates, degrading the overall UL performance.

For example, it is discussed that UE shall not perform TA update within an aTDW (i.e. within a DMRS bundling time window), if that creates phase discontinuity among the UL transmissions in the aTDW, since UE is expected to maintain phase continuity and power consistency within an aTDW. However, such a statement does not address the former problem of performance degradation of DMRS bundling, i.e. the problem that if UE updates its TA very frequently, it would have to create many shorter aTDW, completely losing the performance gain provided by the DMRS bundling feature. For this reason, a point for further study is linked to determination of the duration of the aTDW (i.e. the duration of the DMRS bundling), and in general, on how to ensure that a UE generates the longest possible aTDW to maximize the performance gain offered by the DMRS bundling feature.

To alleviate the problem of performance degradation of DMRS bundling in NTN due to timing drift across the UL repetitions, there is proposed solutions for maximizing the length of the aTDW in DMRS bundling, when UE is subject to the large NTN timing drifts. Although explained in the regime of NTN, the embodiments are applicable to terrestrial networks as well. There is proposed a UE behaviour in which a UE pre-compensates for the timing drift expected to be experienced for a set of UL (e.g. PUSCH/PUCCH) repetitions before the start of the repetitions. This method may have an advantage of maximizing the duration of power consistency and phase continuity (and hence the duration of the aTDW) of DMRS bundling (and consequently increase the gains of DMRS bundling). This may be because with the proposed solutions the UE may not need to cause a discontinuity of the phase reference of the DMRS signals by performing TA updates within a nTDW.

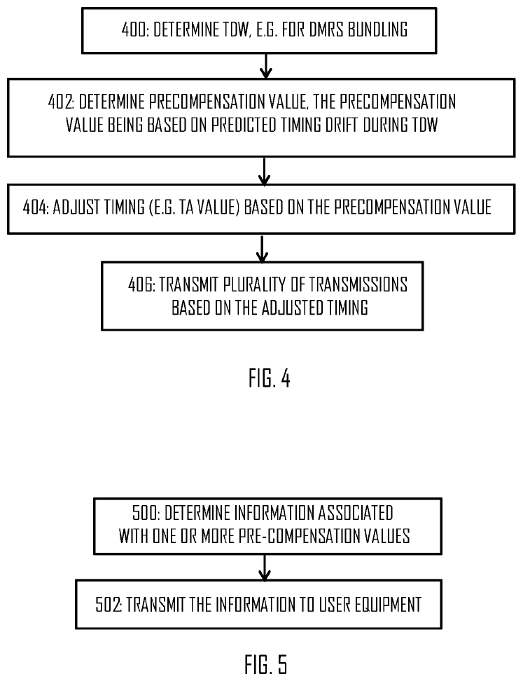

FIG. 4 depicts an example method. The method may be computer-implemented. The method may be performed by a UE, such as the UE 120 of FIGS. 1A and 1B. In an embodiment, the UE 120 is operating in NTN, as in FIG. 1B.

As shown in FIG. 4, the UE 120 in step 400 determines a time domain window (TDW) during which a plurality of transmissions is to take place. In an embodiment the TDW comprises or corresponds to a DMRS bundling window, and wherein the plurality of transmissions comprises transmitting a plurality of DMRSs. In another embodiment, the transmissions comprise data or some other reference signals. In an embodiment, the transmissions are UL transmissions.

The TDW may be determined based on information from a network node, such as from the gNB 110. This information may comprise e.g. the duration of the TDW (e.g. of the nTDW) and/or the number of plurality of transmissions to be performed/scheduled. The UE 120 may further, based on the nTDW, determine length of aTDW during which the phase continuity and power consistency are to be maintained. In an embodiment, the determined TDW corresponds to aTDW. In an embodiment, the determined TDW corresponds to nTDW. Owing to the embodiments, the determined TDW may be longer than in previous solutions.

In step 402, the UE 120 may determine a pre-compensation value for a timing drift value. In an embodiment, the UE determines the value itself, based on boundary limits obtained from the gNB 110. In another embodiment, the gNB 110 provides the value to the UE 120. In yet one embodiment, the UE 120 determines the value without assistance information from the gNB 110.

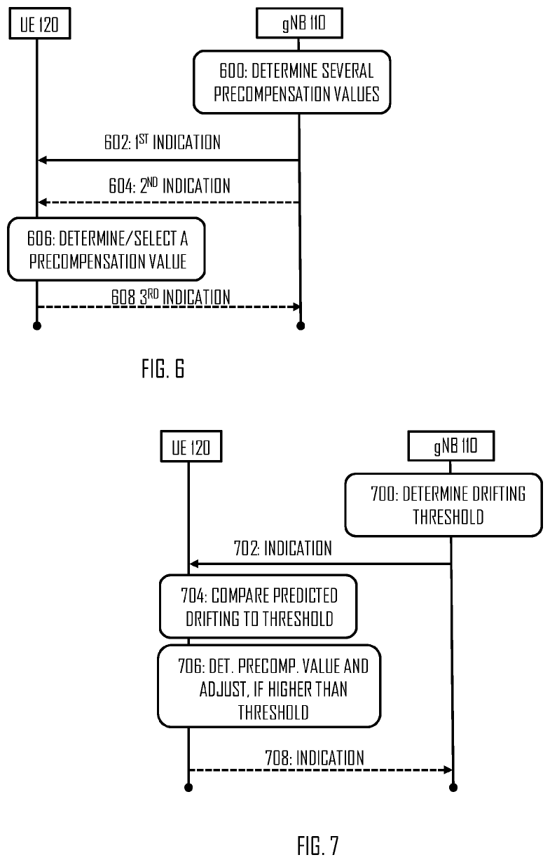

In an embodiment, the pre-compensation value is based on a prediction of a timing drift that is expected to take place on the plurality of transmissions during the TDW. Without predicting and pre-compensating for such timing drift (i.e. drift of the RTT value), some of the plurality of UL transmissions might not be correctly received by the receiver. How to determine the pre-compensation value will be explained later e.g. with reference to FIGS. 6 to 9.

Continuing with FIG. 4, in step 404, the UE 120 adjusts the timing of the plurality of transmissions based on the determined pre-compensation value. This adjustment of the timing takes place before the start of the TDW. However, as the pre-compensation value is based on predicted/estimated timing drift during the determined length of TDW (i.e. future TDW), the proposed solution differs from previous solutions where the

$${N}_{TA , adj}^{UE}$$

takes into account only possible drift in the RTT value up to the start of the TDW. That is, in prior solutions, the UE determines timing drift of the RTT that has already happened from a certain reference period (e.g. epoch time) until current time point and compensates for it by adjusting the TA. On the contrary, in current embodiments, e.g. the UE 120 considers the DMRS bundling window duration, estimates/predicts a timing drift that will occur within it and applies the pre-compensation value corresponding to the predicted timing drift (possibly within network configured limits) before the start of the DMRS bundling window, in order to make sure that all transmissions stay within a cyclic prefix at the receiver until the end of the DMRS bundling window (during which TA cannot be changed to avoid breaking phase and power consistency).

In an embodiment, the adjusting comprises adjusting a timing advance (TA) value based on the determined pre-compensation value.

Although in the following many embodiments are explained so that the adjusting comprises adjusting the TA value, the embodiments are not limited to only such timing adjustment, but also adjusting the timing of the plurality of transmissions after the TA has been applied is an option. In an embodiment, UE's application of the determined value of pre-compensation is performed via addition of the determined pre-compensation value to the current TA value or to the adjusted

$${N}_{TA , adj}^{UE}$$

value to be applied for the upcoming UL repetitions. The resulting value of the TA may be referred to as pre-compensated TA, which in this respect is different than the prior art's

$${N}_{TA , adj}^{UE}$$

value. In this environment, timing advance is itself an adjustment of the transmission timing, so it is possible that the pre-compensation value is directly added to the transmission timing for the first repetition (e.g. DL timing minus TA) or added as another component of the TA for the first repetition.

In step 406, the UE 120 performs the plurality of transmissions (e.g. UL repetitions) within the TDW based on the adjusted timing. That is, the adjusted timing, e.g. the pre-compensated TA value, is applied for each of the plurality of transmissions, without updating the adjusted timing value between the plurality of transmissions.

In an embodiment, in case multiple TDW (e.g. nTDWs) are “back-to-back” in time domain, the UE 120 may perform the timing drift pre-compensation value determination and consequent timing adjustment before each nTDW at the borders between the nTDWs.

In another embodiment, in case the is no back-to-back TDW, the UE 120 may detect an end of the TDW and then perform a further transmission after the end of the TDW based on timing (e.g. based on a time advance value) that is not pre-compensated with the pre-compensation value. That is, at the end of the nTDW, the UE 120 may apply regular UE autonomous timing advance updates, e.g.

$${N}_{TA , adj}^{UE} ,$$

if no other nTDW starts directly after the end of the current/previous TDW.

In an embodiment, the UE 120 determines the TA value for a time instant before the start of the TDW. This may take place based on a TA command from a network node of the NTN (e.g. from gNB 110) and further based on ephemeris data of a satellite node of the NTN. In other words, the UE 120 may adjust the initial TA (possibly obtained at the epoch time) with timing drift that the UE has experienced during a time period between the obtaining of the TA command (indicating the initial TA value) and the start of the TDW. This timing drift that the UE has experienced during that time period may be derivable from the ephemeris data.

Let us then look closer on how the pre-compensation value may be determined (step 402 of FIG. 4) so that the UE may apply it before the start of the TDW, to pre-compensate for part or all of the timing drift expected to be experienced within the TDW for a set of UL (e.g. PUSCH/PUCCH) repetitions. It is noted that the UE is expected to have knowledge of the expected timing drift during the TDW, as the UE knows its own location and direction of movement and the UE also knows the satellite position and direction of movement through the serving satellite ephemeris information. As such, the prediction of the timing drift expected to take place on the plurality of transmissions during the TDW is based on at least one of ephemeris data of a satellite node of the NTN and mobility of the UE 120. The mobility of the UE may comprise information of the expected movement trajectory of the UE during the TDW. In this case, the UE may e.g. estimate the largest timing drift that the UE is expected to experience during the TDW and determine the pre-compensation value based on that.

In an embodiment, shown in FIG. 6, a network node of the non-terrestrial network (e.g. the gNB 110) determines in step 600 a plurality of candidate pre-compensation values. These may comprise a wide range of pre-compensation values. It is noted that the gNB 110 may not know the location of the UE 120 accurately, especially if the UE 120 is in RRC idle or inactive mode, but the gNB 110 may indicate a set of candidate values to the UE based e.g. on the size of the cell(s) the satellite is covering, and in this way at least partially control the value of pre-compensation the UE 120 uses for the adjustment.

In step 602, the UE 120 receives a first indication indicating the plurality of candidate pre-compensation values. This first indication may be sent as a higher layer transmission.

In an embodiment, the gNB 110 later sends a second indication 604, the second indication indicating which candidate pre-compensation value is to be selected (i.e. determined to be used) by the UE 120. In this case the selection/determination of step 606 may be based on the second indication 604 from the network node 110. The indication 604 may be based on gNB determining the pre-compensation value for the UE. For example, the gNB 110 may not know the location of the UE accurately, but the gNB 110 may still indicate a conservative value to the UE 120. For example, if the size is so that the footprint of the satellite covers down to a 30 degrees elevation angle (corresponding to the maximum timing drift value), the gNB 110 could indicate a pre-compensation value based on such elevation angle. In an embodiment, the selection of the pre-compensation value by the gNB 110 may be based on ephemeris data known to the gNB 110 and an evaluation of the UE's coarse location.

The second indication maybe carried on a lower layer than the first indication. The use of lower layer (e.g. L1 or L2) for the second indication may beneficially enable for a dynamic indication of the pre-compensation value to be used, among the more statically configured (e.g. RRC layer) candidate pre-compensation values.

In an embodiment, the UE autonomously selects (i.e. determines) one of the plurality of pre-compensation values, without the second indication. For example, the UE 120 predicts the timing drift that is expected to take place during the time domain window, and selects (i.e. determines) in step 606 the pre-compensation value from the plurality of candidate pre-compensation values which is the next larger value from the predicted timing drift. That is, the UE 120 takes the closest pre-compensation value from the candidate values, which is larger than the predicted timing drift. This embodiment may have the advantage that the UE itself knows its location the best (at current time instant and can possibly also estimate the movement of the UE during the TDW) and can thus most accurately predict the timing drift during the TDW based on the location of the UE, movement trajectory of the UE and/or satellite's ephemeris data. Still, the embodiment allows the gNB 110 in step 602 to provide candidates for the pre-compensation value determination, which allows the gNB 110 to be partially in control of the selection.

In an embodiment, the UE informs the gNB 110 of the selection of the pre-compensation value, as third indication to the network in step 608.

In an embodiment, the adjustment of the timing advance value is performed only when the predicted timing drift exceeds a configured drifting threshold. This is shown in FIG. 7. In step 700, the gNB 110 may determine a threshold level that needs to be exceeded by the predicted timing drift before the UE is allowed to perform the timing (e.g. TA) adjustment based on the pre-compensation value. In step 702, the gNB configuration includes a threshold value on the timing drift. In step 704, the UE compares the predicted timing drift (estimated by the UE 120) to the configured threshold value. If the threshold value is exceeded (e.g. the UE is experiencing a timing drift larger than the configured threshold value), then the UE determines the pre-compensation value and adjusts the timing in step 706 with the pre-compensation value. The pre-compensation value used may be one of the candidate pre-compensation values, as in example of FIG. 6, or determined autonomously by the UE 120 (e.g. corresponding to the predicted timing drift). Optionally, in step 708, the UE informs the gNB 110 that it has adjusted the timing with the pre-compensation value.

In an embodiment, the configured drifting thresholds set by the gNB 110 comprises a negative threshold and a positive threshold, which may or may not be the same. For example, there is one threshold (negative value) applicable for an approaching satellite and one threshold (positive value) for moving-away satellite.

In an embodiment, the gNB in step 702 configures a plurality of drifting threshold values, each associated to e.g. elevation angle. Then, in step 704, the UE predicts the timing drift for the current elevation angle (or for the elevation angle the UE estimates to experience by the end of the TDW) and compares that predicted timing drift value to the threshold value corresponding to the elevation angle, and pre-compensates the timing of the UL transmission(s) only if the predicted timing drift value is larger than the threshold value corresponding to the elevation angle.

In an embodiment, the gNB 110 may determine an upper/lower limit for an allowable pre-compensation value. This way the gNB may control the pre-compensation used by the UE 120. This is shown in FIG. 8, where in step the gNB 110 determines the maximum pre-compensation allowed, and in step 802 indicates this to the UE 120. The UE 120 predicts the timing drift that is expected to take place during the TDW. Then the UE in 804 compares the maximum pre-compensation value to the predicted timing drift. In step 806, the UE 120 determines the pre-compensation value based on the minimum value of the maximum pre-compensation value and the predicted timing drift. In other words, if the predicted timing drift is estimated to be smaller than the maximum allowed pre-compensation, then the UE 120 may determine that the pre-compensation value corresponds to the predicted timing drift, at least in absolute value (it is noted that the pre-compensation value has an opposite sign of the predicted timing drift). On the other hand, if the predicted timing drift is higher than the maximum allowed pre-compensation, then the UE 120 may determine that the pre-compensation value is the maximum allowed pre-compensation value or may determine that it is not allowed to apply the pre-compensation value to the timing of the UL transmission(s). For example, assume the predicted timing drift is 6 ns and the maximum allowed pre-compensation is 5 ns (at least in absolute value), then the pre-compensation to be used by the UE to adjust the timing value is 5 ns. Optionally, in step 808, the UE 120 informs the determined pre-compensation value to the network 110. However, as the gNB has provided an upper boundary to the pre-compensation value, this indication may be omitted.

In an embodiment, the maximum pre-compensation limits set by the gNB 110 comprise a negative limit and a positive limit, which may or may not be the same. For example, there is one maximum pre-compensation limit (negative value) applicable for an approaching satellite and one maximum pre-compensation limit (positive value) for moving-away satellite.

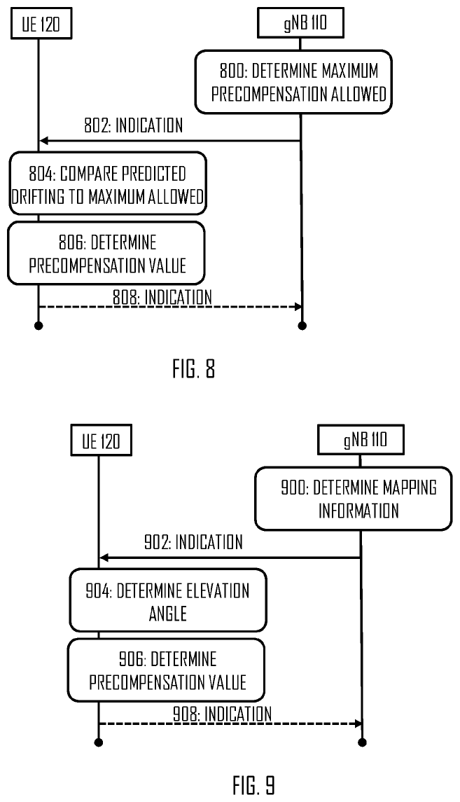

In an embodiment, shown in FIG. 9, the gNB 110 determines and transmits in step 902 to the UE mapping information between pre-compensation values and radio channel characteristic, such as elevation angle or distance, between the UE and the satellite. In an embodiment, the mapping information is different for different satellite constellation/altitudes, e.g. a given elevation angle corresponds to a different pre-compensation value with different satellite constellations. Satellite constellation may reflect the density of the satellites in space or the altitude of the satellites from Earth, for example. In step 906, the UE 120 determines an elevation angle or distance between the UE and the satellite, e.g. before the time domain window or at a predetermined point during the time domain window, e.g. at the end of the TDW. In an embodiment, the elevation angle or distance determined corresponds to the worst timing drift scenario during the TDW. Then, in step 906, the UE 120 selects (i.e. determines) a pre-compensation value corresponding to the determined elevation angle or distance from the mapping information. For example, there is a one-to-one mapping between an elevation angle and its corresponding pre-compensation value. Optionally, in step 908, the UE 120 informs the determined pre-compensation value to the network 110.

In an embodiment, the mapping information is pre-configured to the UE 120, and thus steps 900 and 902 may be omitted from FIG. 9. For example, the mapping information (e.g. table) is hard-coded in specifications, and the one or more pre-compensation values are derived from elevation angle.

It is noted that the embodiments presented in FIGS. 6 to 9 may be combined. For example, the gNB may provide the threshold values discussed in FIG. 7 to the UE and may also provide the candidate pre-compensation values and/or the maximum pre-compensation limits to the UE.

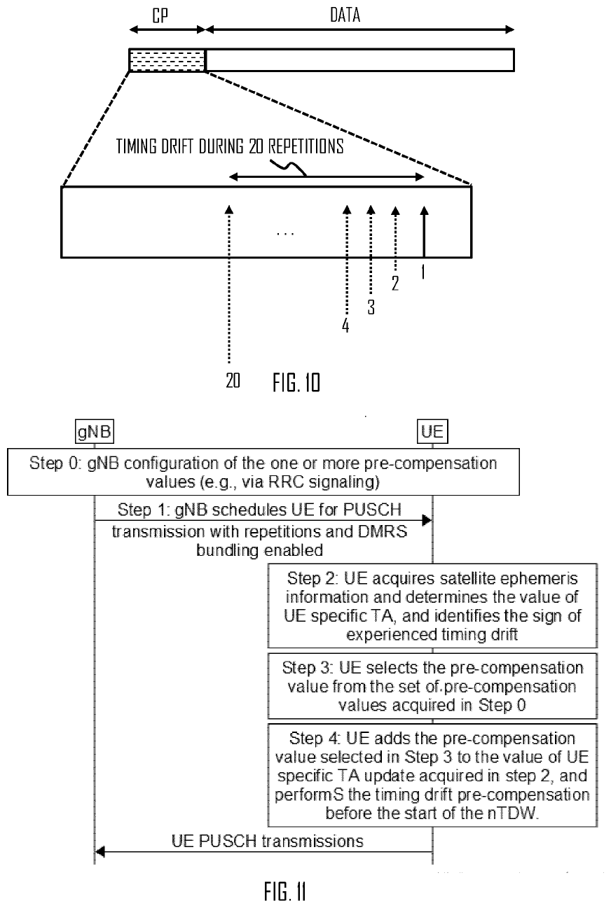

Let us look at one timing drift example with reference to FIG. 10. In this example, the UE is experiencing a negative timing drift. In this example, UE pre-compensation of the timing drift before the start of the UL repetitions leads the uplink transmissions to be received starting from almost the end of the CP for the first repetition (marked as “1” in FIG. 10). However, since the UE is experiencing a negative timing drift, each subsequent repetition will be received earlier in time within the reference cyclic prefix (CP) interval, as shown by the dashed arrows, until the reception time of the last (20th) repetition. In other words, by UE pre-compensation of the total timing drift (timing drift after 20 repetitions in the Figure), the first repetition will be received almost at the end of the CP allowing for larger room for time drifting, when compared to having the first repetition received at (around) the start of the CP, as might happen by prior art implementations (i.e. where

$${N}_{TA , adj}^{UE} and {N}_{TA , adj}^{common}$$

are compensated for) and where no pre-compensation of the timing drift is applied. This UE pre-compensation behaviour in turn allows to maximize the length of the TDW and, thus, the interval of DMRS bundling.

It is to be noted that FIG. 10 represents merely one example for the sake of clarity, but the same approach could be used with a different reception timing of the first repetition (i.e. different pre-compensation value) and also in the case of positive timing drifts.

In an embodiment, the UE 110 may determine (e.g. acquire knowledge of) a CP duration for communication between the UE 120 and the gNB 110. Since it may be that the UE 120 does not exactly know where it is received within the Rx CP at the start of the TDW, as gNB usually leaves some margin to account for UE timing adjustment errors, it is envisaged that the gNB 110 may indicate to the UE 120 such reference point within the CP. Then, the UE 120 may determine the pre-compensation value further based on the cyclic prefix duration such that each of the plurality of transmissions are receivable by the gNB 110 within the cyclic prefix duration, as shown in FIG. 10.

In an embodiment the pre-compensation value is determined to be a negative value when the predicted timing drift is of a positive sign, and the pre-compensation value is determined to be a positive value when the predicted timing drift is of a negative sign.

For example, the UE may consider selecting/determining a negative value of the plurality of candidate values of pre-compensation, if the estimated timing drift for the upcoming UL repetitions within DMRS bundling window is of a positive sign. On the contrary, the UE 120 may consider a positive value from the candidate values of pre-compensation, if the estimated timing drift for the next UL repetitions within the DMRS bundling window is of a negative sign.

From point of view of the network node, FIG. 5 depicts an example method. The method may be computer-implemented. The method may be performed by a network node, such as the gNB 110 of FIGS. 1A and 1B. In an embodiment, the gNB 110 is operating in NTN, as in FIG. 1B.

In step 500, the gNB 110 determines information associated with one or more pre-compensation value. As explained above, a pre-compensation value is useable by a UE 120 for compensating timing drift and is based on a prediction of timing drift that is expected to take place at the UE during the TDW comprising a plurality of transmissions. In step 502, the gNB 110 transmit the information to the UE 120.

In an embodiment, the information comprises a plurality of pre-compensation values allowable to be used by the UE 120 (e.g. the UE may select one of the pre-compensation values, as explained above).

In another or additional embodiment, the information comprises a maximum pre-compensation value allowable to be used by the UE. That, the UE may e.g. predict the timing drift and then determine pre-compensation value, with a limitation that the pre-compensation value needs to be equal to or lower than the provided maximum pre-compensation value.

In yet one embodiment, the information comprises aforementioned mapping information between pre-compensation values and elevation angles between the UE and a satellite of the NTN. The UE may then use the mapping to derive a pre-compensation value to be used, as explained.

FIG. 11 provides a flowchart for a sample implementation of some of the embodiments. For this example, it is assumed that the UE (e.g. the UE 120) is located at 30° elevation angle and experiences negative timing drift, i.e. the satellite is approaching the UE 120.

In step 0 the gNB (e.g. the gNB 110) configures two candidate pre-compensation values {−2, 2} [us] for the NTN UE. The UE can then determine/select the pre-compensation value from these two values, for example. In this example, the set of two candidate pre-compensation values are configured via a higher layer signaling (e.g. RRC). This may correspond to the first indication of step 602 of FIG. 6, or to step 502 of FIG. 5, for example.

In step 1, the gNB schedules the NTN UE for PUSCH transmission with repetitions, e.g., 20 repetitions, and enables DMRS bundling. This allows the UE to determine the TDW length (see step 400 of FIG. 4, for example).

In step 2, the NTN UE acquires satellite ephemeris information, for determination of UE specific TA update

$$( {N}_{TA , adj}^{UE} and {N}_{TA , adj}^{common} ) , ) ,$$

and additionally identifies the sign and value of the timing drift. Here, it is assumed that the NTN UE experiences negative timing drift of −70.5 [us/s] (see FIG. 3), and hence a total timing drift of −1.41 [us] in 20 ms (time of the 20 repetitions).

In step 3, the NTN UE selects the pre-compensation value of 2 μs from the set of RRC configured pre-compensation values signalled in step 0, based on the sign and value of the total expected timing drift identified in step 2. This may thus correspond to step 402 of FIG. 4, for example.

In step 4, before the start of PUSCH transmission with repetitions, at the beginning of TDW, the NTN UE adds the pre-compensation value selected in step 3 to the value of UE specific TA update

$$( {N}_{TA , adj}^{UE} ) ,$$

acquired in step 2, thus performing the timing drift pre-compensation before the start of the TDW (see step 404 of FIG. 4).

In step 5, the NTN UE starts the scheduled PUSCH transmissions with repetitions (to be performed within the determined TDW) and does not update its TA within the TDW. This corresponds to step 406 of FIG. 4.

An embodiment, as shown in FIG. 12, provides an apparatus 10 comprising a control circuitry (CTRL) 12, such as at least one processor, and at least one memory 14 storing instructions that, when executed by the at least one processor, cause the apparatus at least to carry out any one of the above-described processes. In an example, the at least one memory and the computer program code (software), are configured, with the at least one processor, to cause the apparatus to carry out any one of the above-described processes. The memory may be implemented using any suitable data storage technology, such as semiconductor-based memory devices, flash memory, magnetic memory devices and systems, optical memory devices and systems, fixed memory and removable memory. The memory may comprise a database for storing data.

In an embodiment, the apparatus 10 may comprise the terminal device of a communication system, e.g. a user terminal (UT), a computer (PC), a laptop, a tabloid computer, a cellular phone, a mobile phone, a communicator, a smart phone, a palm computer, a mobile transportation apparatus (such as a car), a household appliance, or any other communication apparatus, commonly called as UE in the description. Alternatively, the apparatus is comprised in such a terminal device. Further, the apparatus may be or comprise a module (to be attached to the UE) providing connectivity, such as a plug-in unit, an “USB dongle”, or any other kind of unit. The unit may be installed either inside the UE or attached to the UE with a connector or even wirelessly.

In an embodiment, the apparatus 10 is or is comprised in the UE 120. The apparatus may be caused to execute some of the functionalities of the above described processes, such as the steps of FIG. 4, for example.

The apparatus may further comprise a radio interface (TRX) 16 comprising hardware and/or software for realizing communication connectivity according to one or more communication protocols. The TRX may provide the apparatus with communication capabilities to access the radio access network, for example.

The apparatus may also comprise a user interface 18 comprising, for example, at least one keypad, a microphone, a touch display, a display, a speaker, etc. The user interface may be used to control the apparatus by the user.

The control circuitry 12 may comprise a TA determination circuitry 20 for determining and possibly adjusting the TA based on TA command, satellite ephemeris data and/or UE mobility, according to any of the embodiments. The control circuitry 12 may further comprise a pre-compensation value determination circuitry 22 for determining the pre-compensation value, according to any of the embodiments. The control circuitry 12 may further comprise relevant circuitry/ies for performing the functions, according to any of the embodiments.

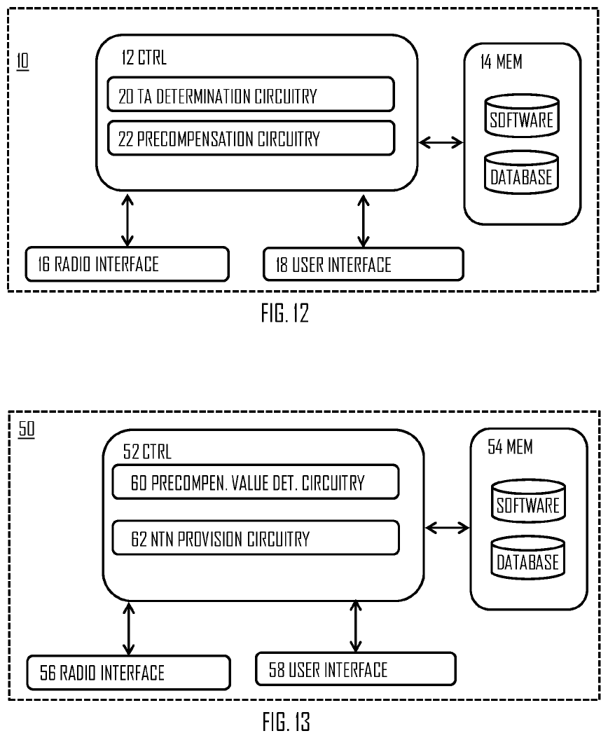

An embodiment, as shown in FIG. 13, provides an apparatus 50 comprising a control circuitry (CTRL) 52, such as at least one processor, and at least one memory 54 storing instructions that, when executed by the at least one processor, cause the apparatus at least to carry out any one of the above-described processes. In an example, the at least one memory and the computer program code (software), are configured, with the at least one processor, to cause the apparatus to carry out any one of the above-described processes. The memory may be implemented using any suitable data storage technology, such as semiconductor-based memory devices, flash memory, magnetic memory devices and systems, optical memory devices and systems, fixed memory and removable memory. The memory may comprise a database for storing data.

In an embodiment, the apparatus 50 may be or be comprised in a network node, such as in gNB/gNB-CU/gNB-DU of 5G. In an embodiment, the apparatus is or is comprised in the network node 110. The apparatus may be caused to execute some of the functionalities of the above described processes, such as the steps of FIG. 5, for example.

The apparatus may further comprise communication interface (TRX) 56 comprising hardware and/or software for realizing communication connectivity according to one or more communication protocols. The TRX may provide the apparatus with communication capabilities with at least one user equipment, for example. The apparatus may be associated with at least one satellite for providing NTN.

The apparatus may also comprise a user interface 58 comprising, for example, at least one keypad, a microphone, a touch display, a display, a speaker, etc. The user interface may be used to control the apparatus by the user.

The control circuitry 52 may comprise a pre-compensation value determination circuitry 60 for determining e.g. the candidate pre-compensation values, according to any of the embodiments. The control circuitry 52 may comprise a NTN provision circuitry 62 for providing network coverage for the NTN. The control circuitry 52 may comprise other relevant circuitry/ies for performing the functions, according to any of the embodiments.

In an embodiment, a CU-DU (central unit-distributed unit) architecture is implemented. In such case the apparatus 50 may be comprised in a central unit (e.g. a control unit, an edge cloud server, a server) operatively coupled (e.g. via a wireless or wired network) to a distributed unit (e.g. a remote radio head/node). That is, the central unit (e.g. an edge cloud server) and the radio node may be stand-alone apparatuses communicating with each other via a radio path or via a wired connection. Alternatively, they may be in a same entity communicating via a wired connection, etc. The edge cloud or edge cloud server may serve a plurality of radio nodes or a radio access networks. In an embodiment, at least some of the described processes may be performed by the central unit. In another embodiment, the apparatus may be instead comprised in the distributed unit, and at least some of the described processes may be performed by the distributed unit. In an embodiment, the execution of at least some of the functionalities of the apparatus 50 may be shared between two physically separate devices (DU and CU) forming one operational entity. Therefore, the apparatus may be seen to depict the operational entity comprising one or more physically separate devices for executing at least some of the described processes. In an embodiment, the apparatus controls the execution of the processes, regardless of the location of the apparatus and regardless of where the processes/functions are carried out.

In an embodiment, an apparatus carrying out at least some of the embodiments described comprises at least one processor and at least one memory including a computer program code, wherein the at least one memory and the computer program code are configured, with the at least one processor, to cause the apparatus to carry out the functionalities according to any one of the embodiments described. According to an aspect, when the at least one processor executes the computer program code, the computer program code causes the apparatus to carry out the functionalities according to any one of the embodiments described. According to another embodiment, the apparatus carrying out at least some of the embodiments comprises the at least one processor and at least one memory including a computer program code, wherein the at least one processor and the computer program code perform at least some of the functionalities according to any one of the embodiments described. Accordingly, the at least one processor, the memory, and the computer program code form processing means for carrying out at least some of the embodiments described. According to yet another embodiment, the apparatus carrying out at least some of the embodiments comprises a circuitry including at least one processor and at least one memory including computer program code. When activated, the circuitry causes the apparatus to perform the at least some of the functionalities according to any one of the embodiments described.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory (ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry.

A term non-transitory, as used herein, is a limitation of the medium itself (i.e. tangible, not a signal) as opposed to a limitation on data storage persistency (e.g. RAM vs. ROM).

As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions described herein, or a combination thereof. For firmware or software, the implementation can be carried out through modules of at least one chip set (e.g, procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Following is a list of some aspects of the invention.

According to a first aspect, there is provided a method, comprising: determining a time domain window during which a plurality of transmissions is to take place; determining a pre-compensation value for a timing drift value, wherein the pre-compensation value is based on a prediction of timing drift that is expected to take place on the plurality of transmissions during the time domain window; adjusting the timing of the plurality of transmissions based on the pre-compensation value; and performing the plurality of transmissions based on the adjusted timing.

Various embodiments of the first aspect may comprise at least one feature from the following bulleted list:
wherein the time domain window comprises a demodulation reference signal bundling window, and wherein the plurality of transmissions comprises transmitting a plurality of demodulation reference signals.
determining a timing advance value for a time instant before the start of the time domain window, wherein adjusting the timing based on the pre-compensation value comprises adding the pre-compensation value to the timing advance value.
wherein the adjusted timing advance value is applied for each of the plurality of transmissions without updating the timing advance value between the plurality of transmissions.
wherein determining the timing advance value for the time instant before the time domain window is based on a timing advance command from a network node of the non-terrestrial network and further based on ephemeris data of a satellite node of the non-terrestrial network.
wherein prediction of the timing drift expected to take place on the plurality of transmissions during the time domain window is based on at least one of ephemeris data of a satellite node of the non-terrestrial network and mobility of the apparatus performing the method.
receiving, from a network node of the non-terrestrial network, a first indication of a plurality of candidate pre-compensation values; and select one of the candidate pre-compensation values; adjusting the timing based on the selected pre-compensation value.
wherein the selection is based on a second indication from the network node, the second indication indicating which candidate pre-compensation value is to be selected.
wherein the first indication is received on a higher layer and the second indication is received on a lower layer.
predicting the timing drift that is expected to take place during the time domain window; and selecting the pre-compensation value from the one or more candidate pre-compensation values which is the next larger value from the predicted timing drift.
wherein adjusting the timing advance value is performed only when the predicted timing drift exceeds a configured drifting threshold.
receiving a maximum pre-compensation value; predicting the timing drift that is expected to take place during the time domain window; and
determining the pre-compensation value based on the minimum among the maximum pre-compensation value and the predicted timing drift.
acquiring mapping information between pre-compensation values and a predetermined radio channel characteristic between the apparatus performing the method and a satellite of the non-terrestrial network; determining a value of the predetermined radio channel characteristic between the apparatus and the satellite before the time domain window; and selecting a pre-compensation value corresponding to the determined value from the mapping information.
wherein the predetermined radio channel characteristic is one of elevation angle and distance.
wherein the mapping information is received from a network node of the non-terrestrial network.
wherein the pre-compensation value is determined to be a negative value when the predicted timing drift is of a positive sign, and the pre-compensation value is determined to be a positive value when the predicted timing drift is of a negative sign.
determining a cyclic prefix duration for communication between the apparatus performing the method and a network node of the non-terrestrial network; and determining the pre-compensation value further based on the cyclic prefix duration such that each of the plurality of transmissions are receivable by the network node within the cyclic prefix duration.
wherein the adjusting the timing based on the pre-compensation value takes place before the start of the time domain window.
detecting an end of the time domain window; and performing a further transmission after the end of the time domain window based on timing that is not adjusted with the pre-compensation value.
wherein the apparatus performing the method is or is comprised in a user equipment operating in the non-terrestrial network.

According to a second aspect, there is provided a method, comprising: determining information associated with one or more pre-compensation values, wherein a pre-compensation value is useable by a user equipment for compensating timing drift and is based on a prediction of timing drift that is expected to take place at the user equipment during a time domain window comprising a plurality of transmissions; transmitting the information associated with the one or more pre-compensation values to the user equipment.

Various embodiments of the second aspect may comprise at least one feature from the following bulleted list:
wherein the information comprises one or more pre-compensation values allowable to be used by the user equipment.
wherein the information comprises a maximum pre-compensation value allowable to be used by the user equipment.
wherein the information comprises mapping between pre-compensation values and elevation angles between the user equipment and a satellite of a non-terrestrial network.

According to a third aspect, there is provided an apparatus, comprising: at least one processor; and at least one memory storing instructions that, when executed by the at least one processor, cause the apparatus at least to: determine a time domain window during which a plurality of transmissions is to take place; determine a pre-compensation value for a timing drift value, wherein the pre-compensation value is based on a prediction of timing drift that is expected to take place on the plurality of transmissions during the time domain window; adjust the timing of the plurality of transmissions based on the pre-compensation value; and perform the plurality of transmissions based on the adjusted timing. Various embodiments of the third aspect may comprise at least one feature from the bulleted list under the first aspect.

According to a fourth aspect, there is provided an apparatus, comprising: at least one processor; and at least one memory storing instructions that, when executed by the at least one processor, cause the apparatus at least to: determine information associated with one or more pre-compensation values, wherein a pre-compensation value is useable by a user equipment for compensating timing drift and is based on a prediction of timing drift that is expected to take place at the user equipment during a time domain window comprising a plurality of transmissions; transmit the information associated with the one or more pre-compensation values to the user equipment. Various embodiments of the fourth aspect may comprise at least one feature from the bulleted list under the second aspect.

According to a fifth aspect, there is provided a computer program product embodied on a distribution medium and comprising program instructions which, when executed by an apparatus, cause the apparatus to carry out the method according to the first aspect.

According to a sixth aspect, there is provided a computer program product embodied on a distribution medium and comprising program instructions which, when executed by an apparatus, cause the apparatus to carry out the method according to the second aspect.

According to a seventh aspect, there is provided a computer program product comprising program instructions which, when executed by an apparatus, cause the apparatus to carry out the method according to the first aspect.

According to an eight aspect, there is provided a computer program product comprising program instructions which, when executed by an apparatus, cause the apparatus to carry out the method according to the second aspect.

According to a ninth aspect, there is provided an apparatus, comprising means for performing the method according to the first aspect, and/or means configured to cause the apparatus to perform the method according to the first aspect.

According to a tenth aspect, there is provided an apparatus, comprising means for performing the method according to the second aspect, and/or means configured to cause the apparatus to perform the method according to the second aspect.

According to an eleventh aspect, there is provided computer implemented system, comprising: a server and at least one radio node; and at least one processor and at least one memory storing instructions that, when executed by the at least one processor, cause the system at least to carry out the method according to the first aspect and/or the method according to the second aspect.

According to a twelfth aspect, there is provided computer implemented system, comprising: one or more processors; at least one data storage, and one or more computer program instructions to be executed by the one or more processors in association with the at least one data storage for carrying out the method according to the first aspect and/or the method according to the second aspect.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus, comprising:
at least one processor; and
at least one memory storing instructions that, when executed by the at least one processor, cause the apparatus at least to:
determine a time domain window during which a plurality of transmissions is to take place;
determine a pre-compensation value for a timing drift value, wherein the pre-compensation value is based on a prediction of timing drift that is expected to take place on the plurality of transmissions during the time domain window;
adjust the timing of the plurality of transmissions based on the pre-compensation value; and
perform the plurality of transmissions based on the adjusted timing.

2. The apparatus of claim 1, wherein the time domain window comprises a demodulation reference signal bundling window, and wherein the plurality of transmissions comprises transmitting a plurality of demodulation reference signals.

3. The apparatus of any of claims 1 to 2, wherein the apparatus is further caused to:
determine a timing advance value for a time instant before the start of the time domain window, wherein adjusting the timing based on the pre-compensation value comprises adding the pre-compensation value to the timing advance value.

4. The apparatus of any of claims 1 to 3, wherein prediction of the timing drift expected to take place on the plurality of transmissions during the time domain window is based on at least one of ephemeris data of a satellite node of the non-terrestrial network and mobility of the apparatus.

5. The apparatus of any of claims 1 to 4, wherein the apparatus is further caused to:
receive, from a network node of the non-terrestrial network, a first indication of a plurality of candidate pre-compensation values; and
select one of the candidate pre-compensation values;
adjust the timing based on the selected pre-compensation value.

6. The apparatus of claim 5, wherein the selection is based on a second indication from the network node, the second indication indicating which candidate pre-compensation value is to be selected, wherein the first indication is received on a higher layer and the second indication is received on a lower layer.

7. The apparatus of claim 5, wherein the apparatus is further caused to:
predict the timing drift that is expected to take place during the time domain window; and
select the pre-compensation value from the one or more candidate pre-compensation values which is the next larger value from the predicted timing drift.

8. The apparatus of any of claims 1 to 7, wherein adjusting the timing advance value is performed only when the predicted timing drift exceeds a configured drifting threshold.

9. The apparatus of any of claims 1 to 8, wherein the apparatus is further caused to:
receive a maximum pre-compensation value;
predict the timing drift that is expected to take place during the time domain window; and
determine the pre-compensation value based on the minimum among the maximum pre-compensation value and the predicted timing drift.

10. The apparatus of any of claims 1 to 9, wherein the apparatus is further caused to:
acquire mapping information between pre-compensation values and a predetermined radio channel characteristic between the apparatus and a satellite of the non-terrestrial network, wherein the predetermined radio channel characteristic is one of elevation angle and distance;
determine a value of the predetermined radio channel characteristic between the apparatus and the satellite before the time domain window; and
select a pre-compensation value corresponding to the determined value from the mapping information.

11. The apparatus of any of claims 1 to 10, wherein the apparatus is further caused to:
determine a cyclic prefix duration for communication between the apparatus and a network node of the non-terrestrial network; and
determine the pre-compensation value further based on the cyclic prefix duration such that each of the plurality of transmissions are receivable by the network node within the cyclic prefix duration.

12. The apparatus of any of claims 1 to 11, wherein the adjusted the timing is applied for each of the plurality of transmissions without updating the timing during the time domain window.

13. The apparatus of any of claims 1 to 12, wherein the apparatus is further caused to:
detect an end of the time domain window; and
perform a further transmission after the end of the time domain window based on timing that is not adjusted with the pre-compensation value.

14. An apparatus, comprising:
at least one processor; and
at least one memory storing instructions that, when executed by the at least one processor, cause the apparatus at least to:
determine information associated with one or more pre-compensation values, wherein a pre-compensation value is useable by a user equipment for compensating timing drift and is based on a prediction of timing drift that is expected to take place at the user equipment during a time domain window comprising a plurality of transmissions;
transmit the information associated with the one or more pre-compensation values to the user equipment.

15. A method, comprising:
determining a time domain window during which a plurality of transmissions is to take place;
determining a pre-compensation value for a timing drift value, wherein the pre-compensation value is based on a prediction of timing drift that is expected to take place on the plurality of transmissions during the time domain window;
adjusting the timing of the plurality of transmissions based on the pre-compensation value; and
performing the plurality of transmissions based on the adjusted timing.
